(19) United States
(12) Patent Application Publication
(10) Pub. No.: US 2007/0122257 A1
(43) Pub. Date: May 31, 2007

(54) Method and apparatus for transporting bulk materials

(76) Inventors: Claus Bauer, Bad Vilbel (DE); Stefan Drewes, Rheinfelden (DE)

Correspondence Address: SMITH, GAMBRELL & RUSSELL, SUITE 3100, PROMENADE II, 1230 PEACHTREE STREET, N.E., ATLANTA, GA, 30307-3592, US

(21) Appl. No.: 11/494,657

(22) Filed: Jul. 27, 2006

(30) Foreign Application Priority Data
Nov. 29, 2005 (DE) 10 2005 056 740.1

(51) Int. Cl. B65G 1/00

(52) U.S. Cl. 414/288

(57) ABSTRACT

Bulk materials are filled in the dry state, under an inert gas atmosphere, into a transporting vessel, which then has an excess inert gas pressure. The operation of emptying the bulk material out of the transporting vessel likewise takes place under an inert gas atmosphere. The method and the apparatus are suitable for transporting bulk materials which are sensitive to air and moisture.

### INTRODUCTION AND BACKGROUND

The invention relates to a method and an apparatus for transporting bulk materials.

Magnesium ethoxylate is a known substance which is used for producing catalysts used, for example, in the production of polyethylene.

Since the magnesium ethoxylate is sensitive to air and moisture, particular protective measures have to be taken during transportation.

In order to exclude air and moisture, it is known for magnesium ethoxylate to be packaged successively in two sacks and then in a vat. In this way, it is possible to achieve, and transport, containers in the order of magnitude of 50 to 100 kg.

This known packaging method has the disadvantage that only a relatively small quantity can be packaged and transported with the 50 kg container. A relatively large quantity of bulk material cannot be expediently packaged and transported in this way.

A further disadvantage with the known packaging method is that the undesirable inclusion of air and moisture cannot be completely ruled out.

The object of the invention has thus been to develop a method and an apparatus which can avoid these disadvantages.

### SUMMARY OF THE INVENTION

The invention relates to a method for transporting bulk materials which is characterized in that a transporting vessel is flushed with an inert gas until only the inert gas is present in the transporting vessel, the bulk material is then filled into the transporting vessel under an inert gas atmosphere such that the ingress of air or moisture is avoided and, following completion of the filling operation, an excess inert gas pressure is present in the transporting vessel, and, if appropriate, the operation of emptying the bulk material out of the transporting vessel is likewise carried out under an inert gas atmosphere.

The transporting vessel may be arranged in a carrying structure which allows the transporting vessel to be stacked and transported in containers.

The invention also relates to an apparatus for implementing the method for transporting bulk materials according to the invention, the apparatus being characterized in that the transporting vessel 2 is arranged, if appropriate, in a carrying frame 1, an introduction opening 15, a pressure-relief valve 26, an outlet valve 27 and an inlet valve 8 being arranged on the top 5 of the transporting vessel 2 and the exit opening 9 being arranged on the base of the transporting vessel.

The invention further relates to an adapter for the apparatus according to the invention, the adapter being characterized in that it comprises the cylindrical part 18, on which the two plate rings 19 and 20 are arranged, the coupling bolts 17 being arranged on the plate ring 19 and the bores 21 being arranged, at regular spacings, on the plate ring 20.

### BRIEF DESCRIPTION OF DRAWINGS

The method according to the invention and the apparatus according to the invention are described and explained in more detail with reference to the accompanying drawings, in which:

FIG. 1 shows the apparatus according to the invention in side view A,

FIG. 2 shows the apparatus according to the invention in side view B,

FIG. 3 shows the plan view of the apparatus according to the invention,

FIG. 4 shows the filling opening on the top side of the apparatus according to the invention,

FIG. 5 shows the adapter according to the invention, and

FIG. 6 shows the adapter according to the invention in side view.

### DETAILED DESCRIPTION OF INVENTION

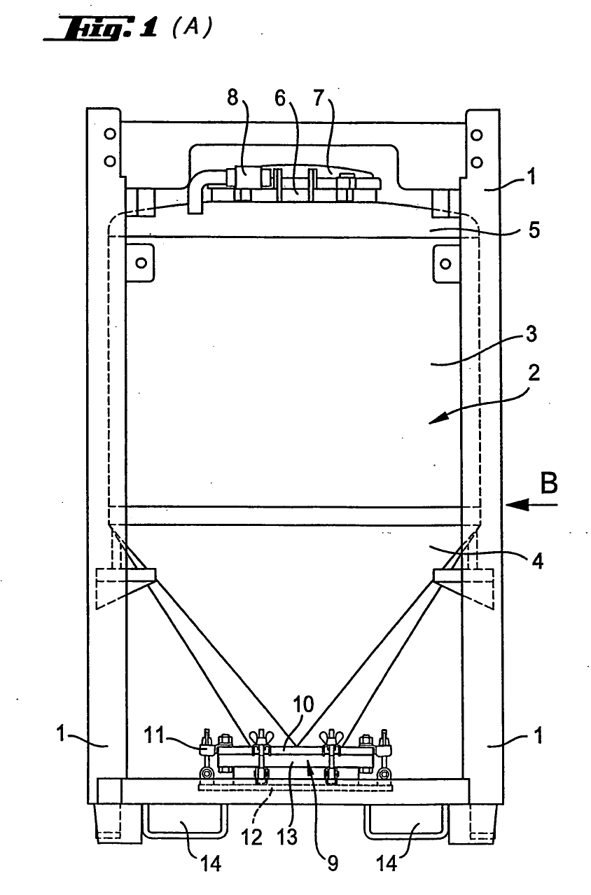

According to FIG. 1, which shows the side view A of the apparatus according to the invention, the transporting vessel 2 is arranged in the carrying frame 1. The transporting vessel 2, which may have a volume of 1000 litres and be produced from stainless steel, comprises the cuboidal top part 3 and the conically formed base 4. Arranged on the top 5 of the transporting vessel 2 is the manhole 6, which can be closed in a gas-tight manner by the screw cover 7 and six eyebolts. Also arranged on the top 5 of the transporting vessel 2 is the gas-tight quick-action coupling, for example a Stäubli coupling 8.

The exit opening 9 is arranged on the conically formed base 4 of the transporting vessel, which may have a pouring angle of 45°. The exit opening has the round flange 10 with six suspension lugs 11 for coupling bolts. The cover 12 is arranged on the round flange 10 by way of hinged bolts. Furthermore, the shut-off flap 13 with sealing sleeve is arranged in the exit opening 9. The carrying frame 1 has, at the bottom end, drive-in brackets 14 for the fork-lift truck.

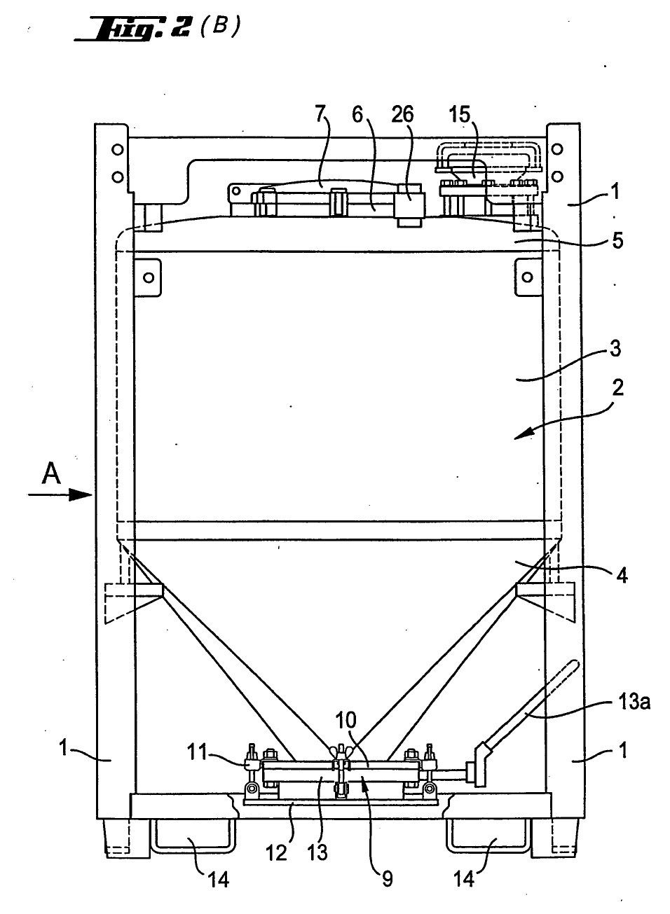

According to FIG. 2, which shows the side view B, which is at an angle of 90° in relation to the side view A, the shut-off flap 13 is arranged on the exit opening 9. The shut-off flap 13 is actuated by means of the lever 13a.

The introduction opening 15 is arranged on the top 5, alongside the manhole 7.

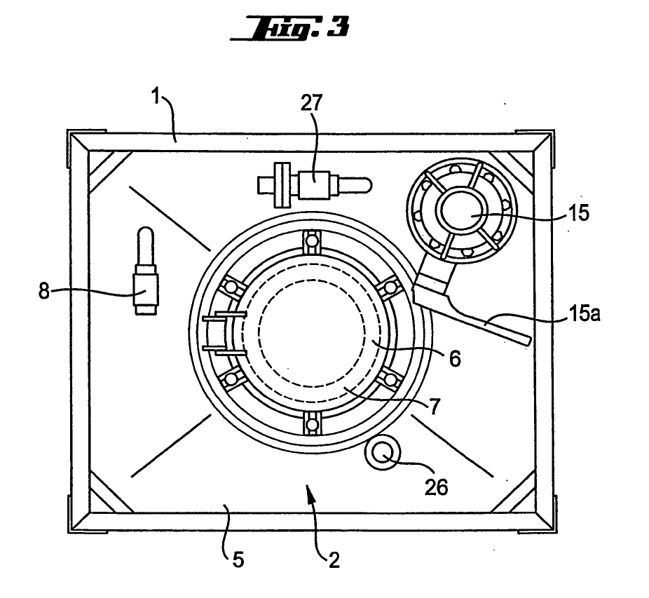

According to FIG. 3, which shows the apparatus according to the invention in plan view, the manhole 6 with the screw cover 7 is arranged on the top 5. Also arranged on the top 5 are the pressure-relief valves 26, the gas-tight quick-action coupling, for example a Stäubli coupling 8, the connector 27 for the inert gas, for example nitrogen, and the introduction opening 15.

The introduction opening 15 has a shut-off flap which can be actuated by the lever 15a.

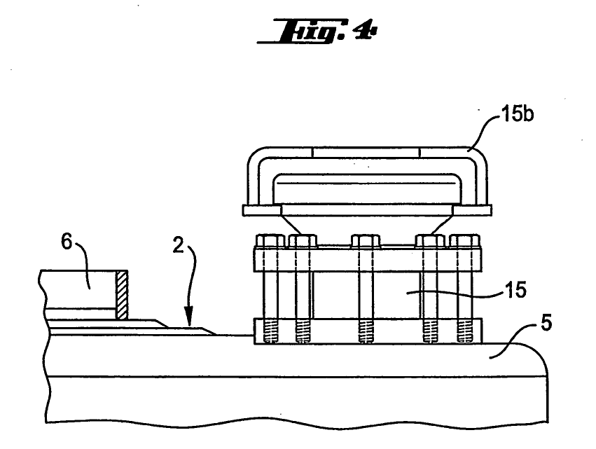

According to FIG. 4, the introduction opening 15 is arranged on the top 5 of the transporting vessel 2. Arranged on the introduction opening 15, which can be closed in a gas-tight manner, is the means 15b by which the introduction hopper (not illustrated) can be retained on the introduction opening 15 in a gas-tight position.

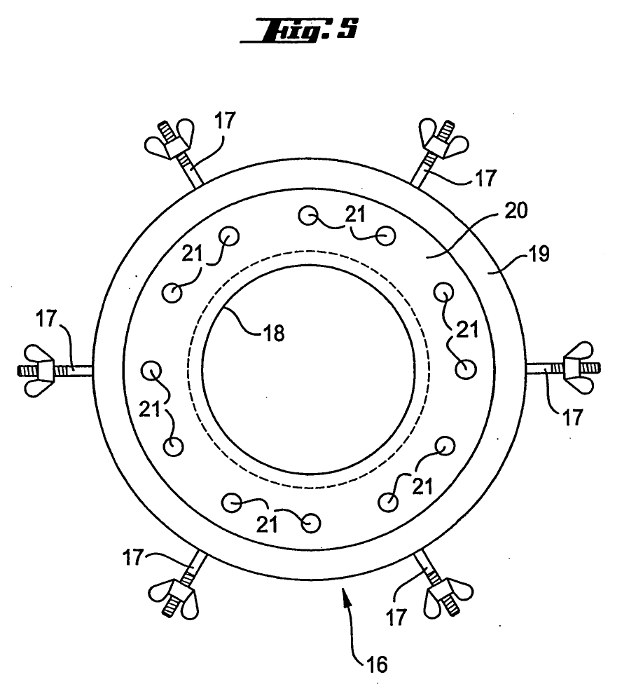

According to FIG. 5, the coupling bolts 17, which can be moved in the axial direction by means of hinges, are arranged on the adapter 16. The adapter 16 comprises a cylindrical part 18, on which the two circular plate rings 19 and 20 are welded. The coupling bolts 17 are arranged on the plate ring 19. Bores 21 are arranged, at regular spacings, on the plate ring 20. The coupling bolts 17 serve for fastening the adapter, via the plate ring 19, on the exit opening 9 of the transporting vessel 2.

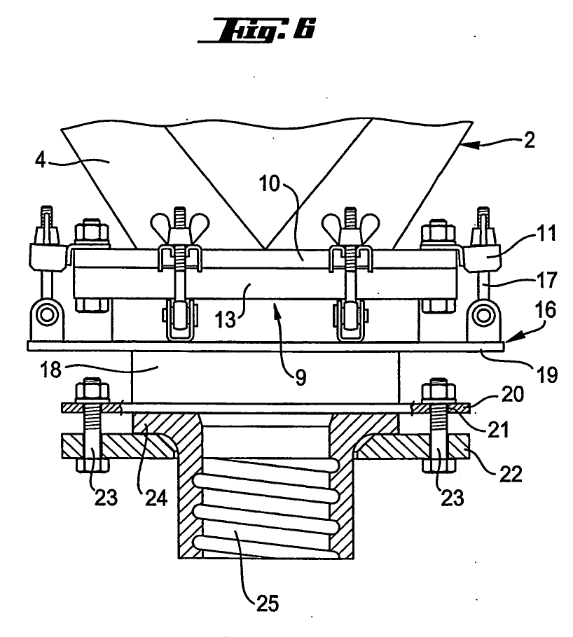

According to FIG. 6, the attachment flange 22 is fastened on the exit opening 9 of the transporting vessel 2 by means of the bores 21 on the plate ring 20. Use is made here of the screws 23, and the seal 24 of the hose 25 is retained between the plate ring 20 and the attachment flange 22. The cover 12 has been removed prior to the adapter 16 being fastened.

According to the invention, the bulk material, for example magnesium ethoxylate, is introduced into the transporting vessel 2, by the introduction means, once the transporting vessel 2 has been completely flooded with nitrogen. In this case, the introduction means is positioned in a gas-tight manner on the introduction opening 15. The bulk material flows into the transporting vessel 2, it being possible for nitrogen to flow out of the vessel via the connector 27, which is provided with a threaded ball valve. Following completion of the filling operation, the introduction opening is closed in a gas-tight manner, an excess pressure of not more than 0.1 bar having to be present in the transporting vessel. The excess pressure can be a maximum of 0.1 bar.

For emptying the transporting vessel 2, the latter is positioned in a gas-tight manner, by way of the exit opening 9, on the vessel which is to be filled. As the bulk material runs out, inert gas is introduced into the transporting vessel 2 via the gas-tight quick-action coupling, for example a Stäubli coupling 8, in order to avoid the ingress of air or moisture during the emptying operation.

By means of the method according to the invention and of the apparatus according to the invention, it is advantageously possible for bulk materials which are sensitive to air and moisture, for example magnesium ethoxylate, to be transported in an undamaged state and transferred from one vessel to another without any dust forming. Furthermore, it is possible for relatively large quantities of over 100 kg up to 350 kg of bulk material to be transported.

German priority application number 10 2005 056 740.1, filed in the German Patent Office on Nov. 29, 2005, is relied on and incorporated herein by reference.

1. Method for transporting bulk materials, comprising providing a transporting vessel, flushing the transporting vessel with an inert gas until only the inert gas is present in the transporting vessel, introducing a bulk material into the transporting vessel under an inert gas atmosphere in a filling operation such that the ingress of air or moisture is avoided and, following completion of the filling operation, an excess inert gas pressure is present in the transporting vessel.

2. The method according to claim 1, further comprising emptying the bulk material out of the transporting vessel under an inert gas atmosphere.

3. The method according to claim 1, wherein the inert gas is nitrogen.

4. The method according to claim 1, wherein the bulk material is sensitive to air and/or moisture.

5. The method according to claim 4, wherein the bulk material is magnesium ethoxylate.

6. The method according to claim 1, further comprising following completion of the filling operation closing the vessel in a gas tight manner whereby an excess pressure is present in the transporting vessel that amounts to not more than 0.1 bar.

7. The method according to claim 2, further comprising introducing inert gas into the transporting vessel as the bulk material runs out during emptying.

8. Apparatus for implementing the method for transporting bulk materials according to claim 1, comprising a transporting vessel having a top and a base, optionally arranged in a carrying frame, there being an introduction opening, a pressure-relief valve, an outlet valve and an inlet valve arranged on the top of the transporting vessel and an exit opening being arranged on the base of the transporting vessel.

9. The apparatus according to claim 8, further comprising an adapter is arranged on the exit opening.

10. An adapter for the apparatus according to claim 9, comprising a cylindrical part, on which two plate rings are arranged, a plurality of coupling bolts being arranged on one of the plate rings and bores being arranged, at regular spacings, on a second of the plate rings.
